(19) United States
(12) Patent Application Publication
(10) Pub. No.: US 2015/0287279 A1
(43) Pub. Date: Oct. 8, 2015

(54) CHANCE BASED LOYALTY PROGRAM USING AN INTERACTIVE GAME

(71) Applicant: Timothy C. Nichols, San Jose, CA (US)

(72) Inventor: Timothy C. Nichols, San Jose, CA (US)

(21) Appl. No.: 14/245,393

(22) Filed: Apr. 4, 2014

(51) Int. Cl. G07F 17/32

(52) U.S. Cl. CPC G07F 17/3244

(57) ABSTRACT

There are provided systems and methods for a chance based loyalty program using an interactive game. A user may purchase items at a merchant that generate a transaction history. The user may be provided credits to a game of chance based on the transaction history and loyalty account. By playing the chance game, the user may win purchase credits with the merchant, such as discounts, free items, or rebates. The odds to win the chance game may be specific to the user and set by the merchant. The odds may also be recalculated to enforce the odds set by the merchant. By playing the chance game, the user may be added to a leaderboard that compares the user to other users based on their respective purchases and loyalty accounts. Winnings and/or number of credits provided to the user may depend on the user's ranking on the leaderboard.

### TECHNICAL FIELD

The present application generally relates to a chance based loyalty program using an interactive game and more specifically to providing a user with an interactive chance game on a user device that may be utilized with a loyalty program to provide benefits for shopping with a merchant.

### BACKGROUND

Merchants may offer loyalty programs to users. A loyalty programs may offer a user benefits by virtue of being enrolled in the loyalty programs, such as a sale price of an item or service while the user is shopping. Such loyalty programs may be utilized by a merchant as a way to receive user information for use in future advertising and determining demographic information. Additionally, certain merchants may offer benefits to the user when the user purchases items at the merchant. For example, the user may receive coupons, discount offers, etc., based on an amount the user shops at the merchant. Thus, users who spend larger amounts at a merchant may receive larger savings. Both types of loyalty programs are straightforward, whereby a user performs some action with the merchant to receive savings. Thus, the user is reasonably informed of the potential savings the user may receive when performing those actions with the merchant. If a user is not about to receive savings, the user may forego signing up for a loyalty account or purchasing from that merchant. Additionally, such programs are passive and do not actively entice a user to shop with the merchant. Thus, a user is not always incentivized to join a loyalty program or purchase with the merchant.

### BRIEF DESCRIPTION OF THE DRAWINGS

FIG. 1 is a block diagram of a networked system suitable for implementing the processes described herein, according to an embodiment;

FIG. 2 is an exemplary system environment with a user device displaying a chance game playable by a user, according to an embodiment;

FIG. 3 is a flowchart of an exemplary process for a chance based loyalty program using an interactive game, according to an embodiment; and

FIG. 4 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

A user may enroll in a loyalty program with a merchant that provides for benefits to the user, such as sale discounts, free items or services, rebates, and/or monetary credits to the merchant based on purchases by the user. When a user purchases an item or service from the merchant, such as through a merchant location or using an online portal for the merchant, the user may be provided with credits to play a chance game to win the benefits for the merchant. The chance game may be game where a user has odds to win a prize by playing the game. For example, a chance game may be a card game, a slot machine game, a roulette wheel game, a lottery game (e.g., a pick number, door, cup, etc., type game), or a matching game (e.g., a picture matching game, a scratcher type game, etc.). The chances of the user winning depend on information about the user, such as how many times the particular user has played without winning, in which case, the user's odds of winning may go up each time the user does not win something. Thus, the odds may be specific to the user.

The user may earn credits to play the game through generating a transaction history with the merchant. The transaction history may include a receipt or other identification of purchases with the merchant. The user may receive a credit simply by generating any transaction history. However, in other embodiments, the credit may depend on an amount spent or a type/size/brand/etc. of item purchased. Additionally, a type of credit may depend on the transaction history. For example, a 100 point credit may be awarded to a sandwich purchase, whereas a 200 point credit is award to a dinner meal purchase. Moreover, the number and/or type of credits provided to the user may further depend on the loyalty account of the user. Thus, users who frequently shop at the merchant may receive more and/or higher valued credits. Users who infrequently visit the merchant may be awarded more and/or higher value credits to incentivize the user to more often purchase items at the merchant. The merchant may also set the odds to win the game based on other factors, such as geographical/regional considerations (e.g., per store odds, per chain odds, per city odds, etc.), a number of people playing the chance game, a number of people using the chance game, etc.

By playing the chance game using the credits, the user may be provided with a purchase credit for the merchant if the user wins the chance game. As previously discussed, these purchase credits may take the form of a benefit at the merchant. The merchant or other entity may establish odds to win the chance game, such as a 1 in 10 chance to win the game. In order to insure a user wins the chance game in a set number of plays, the odds may be dynamically adjusted to enforce a win every number of plays of the chance game by the user. Thus, if a user wins the chance game on the first credit/play, the likelihood the user wins on the next credit/play may be low. Moreover, if the user fails to win on the first credit/play and/or subsequent credits/plays, the odds may increase until at N number of plays the user will always win the chance game, where N is set by the merchant and corresponds to the odds of the chance game. Therefore, the odds may increase or decrease based on the user's wins over the set amount of plays by the merchant, and the odds may be specific to the user playing the chance game based on the user's past behavior. The merchant may set odds for a plurality of items that may be won through the chance game. For example, the chance game may award a free sandwich at 1 in 10 odds, but a free fountain drink at 1 in 5 odds. The merchant may also utilize the purchase credits and odds to win the game to promote specific items and/or services.

In addition to the chance game, the merchant may provide for a leaderboard that ranks the purchases, wins, and/or progress of the user against other users using the same loyalty program and/or playing the same chance game. The user may be assigned an adjustable ranking based on transaction histories of the user, the loyalty account of the user (including length of possession, past purchases using the loyalty account, credits awarded to the loyalty account, etc.), and/or winnings in the chance game by the user. The ranking may be in relation to other users and may correspond to a score, a numerical ranking, a class, a level, or other progress determination. In addition to viewing the user's ranking in relation to other users, the ranking/leaderboard may be utilized to determine a type of item redeemable using the purchase credit. Thus, higher ranked users may receive higher valued items through the purchase credit. The ranking/leaderboard may also be used to determine a number of credits to the chance game to award the user.

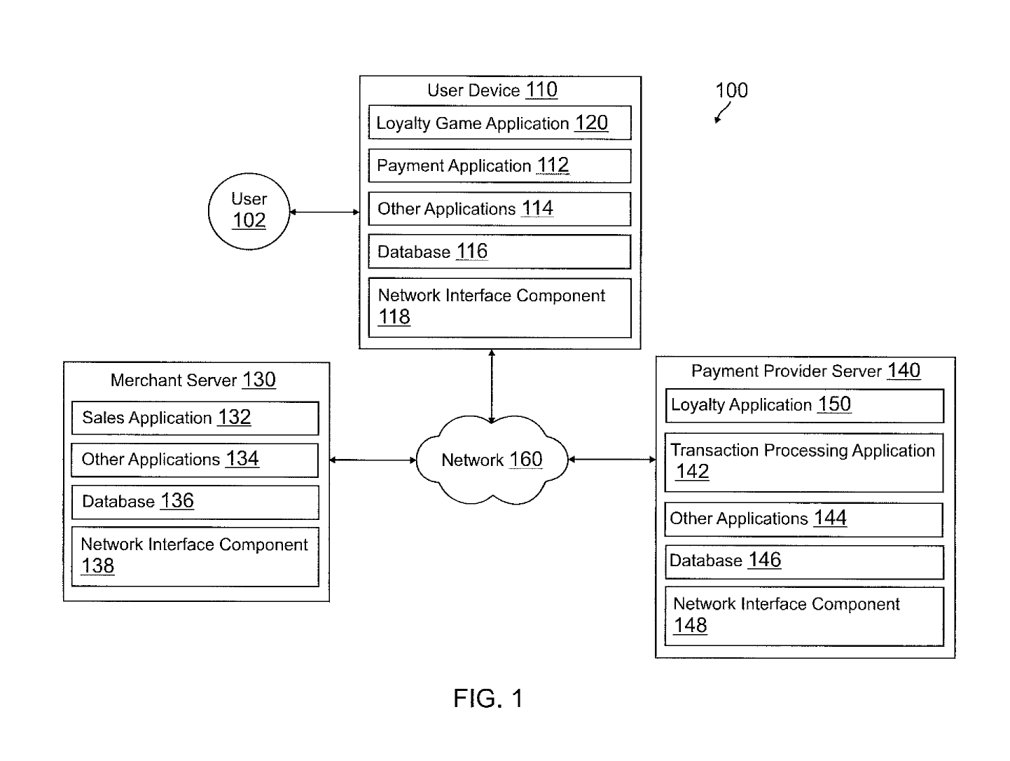

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a user device 110, a merchant server 130, and a payment provider server 140 in communication directly and/or over a network 160. User 102 may utilize user device 110 to execute a loyalty game application that provides discounts, free merchandise (e.g., items and/or services), or other potential benefits with a merchant corresponding to merchant server 130 based on wins of a chance game. Payment provider server 140 may maintain information for the loyalty account and work in corroboration with merchant server 130 to provide user 102 credits to play the loyalty game application. In various embodiments, one or more functions provided by payment provider server 140, such as providing and maintaining a loyalty account with merchant server 130, may be provided by merchant server 130.

User device 110, merchant device 130, and payment provider server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

User device 110 may be implemented using any appropriate hardware and software configured for wired and/or wireless communication with merchant device 130 and/or payment provider server 140. For example, user device 110 may be implemented as a personal computer (PC), a smart phone, laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. Although a user device is shown, the user device may be managed or controlled by any suitable processing device. Although only one user device is shown, a plurality of user devices may function similarly.

User device 110 of FIG. 1 contains a loyalty game application 120, a payment application 112, other applications 114, a database 116, and a network interface component 118. Loyalty game application 120, payment application 112 and other applications 114 may correspond to processes, procedures, and/or applications executable by a hardware processor, for example, a software program. In other embodiments, user device 110 may include additional or different software as required.

Loyalty game application 120 may correspond to an application that enables user 102 to play a chance game for benefits with a merchant corresponding to merchant server 130 using credits received from payment provider server 140. In this regard, loyalty game application 120 may receive credits for playing the chance game based on transaction histories with merchant server 130. Loyalty game application 120 may receive the credits after payment application 112 completes a purchase with a merchant for merchant server 130 and transmits the transaction history to merchant server 130 and/or payment provider server 140. Based on the transaction history, merchant server 130 and/or payment provider server 140 may provide loyalty game application 120 with one or more credits, or type of credits, to play the chance game. For example, a credit may include a token to initiate a turn/spin of the chance game, an amount to wager during the chance game, a number or numbers (or other symbol(s)) to match during the chance game, etc., and may depend on a ranking in a scoreboard of user 102. Generation of the transaction history for provision of a number, type, and/or denomination of credits will be explained in more detail under payment application 112 and payment provider server 140, respectively.

Once one or more credits are provided to loyalty game application 120, user 102 may engage in one or more turns of the chance game provided by loyalty game application 120. A chance game may include a card game, a slot machine game, a roulette wheel, a lottery game, a matching game, or any other game where a user is given user specific odds to win the game. A chance game may involve games that require some amount of skill by the user that may alter the odds, such as poker, a memory game, etc. By playing the credits) with the chance game, user 102 may be given odds to win a benefit with a merchant corresponding to merchant server 130. A benefit may correspond to a purchase credit with the merchant. For example, a purchase credit may include a discount, a free item or service, a rebate, a monetary credit, or another credit that provides some savings to user 102 at the merchant. Purchase credits may also correspond to promotional items that a merchant corresponding to merchant server 130 would like to promote or sell (e.g., a new type of lotion at a beauty supply store). Loyalty game application 120 may also receive a purchase credit that depends on a ranking in a scoreboard for user 102, as will be explained in more detail here.

If user 102 wins a purchase credit with a merchant corresponding to merchant server 130, odds for the chance game with loyalty game application 120 may change as dictated by merchant server 130 and/or payment provider server 140. Loyalty game application 120 may have specific odds for winning the game by user 102 initially. For example, user 102 may be given 1 in 10 odds to win the chance game by loyalty game application 120. Merchant server 130 may set the odds based on a policy of merchant server 130. Additionally, odds may reflect changes in the game based on user skill. Thus, in a game of skill and luck, such as a memory game, odds may factor in different users skill with the game. In the above example, if user 102 fails to win the game in 10 tries, the chance game may increase in odds so that user 102 is given 1 in 9, 1 in 8, or lower odds to win the chance game. Thus, loyalty game application 120 may prevent a potential unlucky streak where user 102 does not win the chance game for a multitude of turns. Once user 102 wins the chance game with loyalty game application 120, loyalty game application 120 may change the odds of the chance game based on user 102's past winnings. Thus, if user 102 wins once after 10 tries in the above example, the odds may be set to 1 in 10 again, or may stay at a lower set of odds to give user 102 an equal likelihood of winning twice in 20 tries. Conversely, if user 102 wins before 10 tries, the odds set by loyalty game application 120 may change to make it more unlikely that user 102 will win in the next 10 tries, such as 1 in 11, 1 in 12, etc., odds. Therefore, loyalty game application 120 may adapt the odds based on the past winnings of user 102 in the chance game to enforce a set number of wins per number of game plays in the chance game. Moreover, odds may change based on how often user 102 visits a merchant corresponding to merchant server 130. Thus, to incentivize user 102 to revisit the merchant if user 102 has not visited the merchant in a set period of time, the odds for the chance game may increase, i.e., give the user a better chance of winning the game initially. As user 102 plays the chance game and/or has other interactions with merchant server 130 and/or a merchant corresponding to merchant server 130, the odds may change to user 102. Thus, the odds may be specific to user 102 and adjust based on the behaviors of user 102.

In various embodiments, the chance game available with loyalty game application 120 may provide more than one potential win of the chance game. For example, a chance game may be a slot game, whereby matching 3 soda icons may win a free soda, matching 3 French fries icons may win a free French fries, and matching 3 hamburger icons may win a free hamburger. Thus, the purchase credit provided by loyalty game application 120 may depend on the specific winnings of user 102 in the chance game. In other embodiments, user 102 may win an amount of purchase credits in the chance game, such as a number of purchase credits won through a poker or blackjack style game. In such embodiments, user 102 may utilize the purchase credits to redeem benefits with a merchant corresponding to merchant server 130 at different levels. For example 100 purchase credits may win a free appetizer, while 500 purchase credits win a free dinner. In other embodiments, the type of credit used to play the chance game may affect the type of purchase credit awarded. Thus, if user 102 is given a credit that may win a “20% off purchases of more than $50” purchase credit in loyalty game application 120, user 102 may only win that purchase credit, and not potentially a “free necklace with purchase of a dress” purchase credit.

If user 102 wins a purchase credit playing the chance game, user 102 may redeem the credit using payment application 112. Payment application 112 may be used, for example, to provide a convenient interface to permit user 102 to select payment options and provide payment for the purchases. Payment application 112 may be implemented as an application having a user interface enabling the user to enter payment options for storage by user device 110, provide payment on checkout of an item/service with merchant server 130 and/or payment provider server 140, and complete a transaction for the item/service with merchant server 130 and/or payment provider server 140. In certain embodiments, payment application 112 may correspond more generally to a web browser configured to view information available over the Internet or access a website corresponding to a payment provider.

Payment application 112 may utilize user financial information, such as a credit card, bank account, or other financial account to complete payment. In various embodiments, payment application 112 may access purchase credits won in loyalty game application 120 to provide payment for items and/or services. Additionally, payment application 112 may provide payment for items and/or services using a user account with the payment provider, such as payment provider server 140. Payment application 112 may include cross-linking, allowing user 102 to identify a user account through an identifier for a separate user account (e.g. identifying a user account through a debit card account number and vice versa). Payment application 112 may further include options to store transaction histories for purchased items/services, such as receipts, for later use, including redemption of the purchased items/services at a physical merchant location and/or transmission to merchant server 130 and/or payment provider server 140. As previously discussed, merchant server 130 and/or payment provider server 140 may utilize the transaction histories to provide credits to loyalty game application 120 for the chance game. Thus, payment application 112 provides an interface enabling user 102 to provide proof of purchase of items/services to a merchant. Payment application 112 may further be utilized to provide shipping options for the delivery of the purchased items/services.

User device 110 includes other applications 114 as may be desired in particular embodiments to provide features to user device 110. For example, other applications 114 may include security applications for implementing client-side security features, programmatic client applications for interfacing with appropriate application programming interfaces (APIs) over network 160, or other types of applications. Other applications 114 may also include email, texting, voice and IM applications that allow a user to send and receive emails, calls, texts, and other notifications through network 160. In various embodiments, other applications 114 may include financial applications, such as banking, online payment, money transfer, or other applications associated with payment provider server 140. Additionally, other application may include browser applications, social media applications, camera applications, and/or mapping/check-in applications. Other applications 114 may contain other software programs, executable by a processor, including a graphical user interface (GUI) configured to provide an interface to the user.

User device 110 may further include database 116 which may include, for example, identifiers such as operating system registry entries, cookies associated with loyalty game application 120, payment application 112, and/or other applications 114, identifiers associated with hardware of user device 110, or other appropriate identifiers, such as identifiers used for payment/user/device authentication or identification. In one embodiment, identifiers in database 116 may be used by user device 110, merchant server 130, and/or payment provider server 140, to associate user device 110 with a particular account maintained by payment provider server 140. Database may include information utilized by loyalty game application 120 including odds for the chance game with loyalty game application 120, credits to play the chance game of loyalty game application 120, and/or purchase credits won in the chance game of loyalty game application 120. Database 116 may include transaction histories usable to present proof of purchase of items and/or services to merchant server 130 and/or payment provider server 140.

Database 116 may include information used by payment application 112 to provide payment for items and/or services, for example, user personal information (e.g. a name, social security number, user financial information, or other identifying information), a user account identifier (e.g. user account identifier is at least one of a user identifier, a user credit or debit card number, a user account name, and a user account number), a user device identifier, and/or purchase credits. In various embodiments, database 116 may include online account access information.

In various embodiments, user device 110 includes at least one network interface component 118 adapted to communicate with merchant server 130 and/or payment provider server 140. Network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices.

Merchant server 130 may correspond, for example, to a merchant or seller offering various items and/or services for sale to user 102 through a merchant location. Generally, merchant server 130 may be maintained by anyone or any entity that receives money in exchange for items and/or services, which includes restaurants, charities, merchandise retailers, etc. Merchant server 130 may correspond to a server that provides items and/or services to user 102 alone, for example, EBAY® Inc. of San Jose, Calif., USA. In other embodiments, merchant server 130 may correspond to one or more merchants having a merchant location where user 102 may purchase items and/or services.

Merchant server 130 may include processing applications, which may be configured to interact with user device 110 and/or payment provider server 140 to facilitate the sale of items and/or services and provide benefits through a loyalty program to user 102. Although merchant server 130 is shown as separate from payment provider server 140, it is understood one or more of the features described below in reference to merchant server 130 may be incorporated within payment provider server 140, and vice versa. Although only one merchant server is shown, a plurality of different merchant servers may function similarly.

Merchant server 130 includes a sales application 132, other applications 134, a database 136, and a network interface component 138. Sales application 132 and other applications 134 may correspond to processes, procedures, and/or applications executable by a hardware processor, for example, a software program. In other embodiments, merchant server 130 may include additional or different software as required.

Sales application 132 may be configured to provide sales information for items and/or services available with a merchant corresponding to merchant server 130 and provide information and benefits for a loyalty account held by user 102. In this regard, sales application 132 may access and provide an inventory of items and/or services available with a merchant correspond to merchant server 130 to user 102 and complete payment for one or more of those items and/or services with user 102. Completion of payment may utilize payment provider server 140. Completion of a payment with user 102 may generate a transaction history that may be transmitted to payment provider server 140 for use with the loyalty account of user 102 with merchant server 130. As previously discussed, although payment provider server 140 is shown in FIG. 1 as managing the loyalty account and associated chance game, in various embodiments, merchant server 130 may provide and manage loyalty accounts and chance games for user 102.

Sales application 132 may further dictate the odds for a chance game provided by loyalty game application 120. Thus, a merchant administrator utilizing merchant server 130 may set the odds to win the chance game user 102 may play with loyalty game application 120. Moreover, sales application 132 may further determine the type of credits provided to loyalty game application 120 for playing the chance game as well as the purchase credits available to win while playing the chance game (e.g., what type of benefit user 102 may redeem with a purchase credit, the purchase credit cost for redeeming one or more benefits, the type of item/service redeemable with one or more purchase credit etc.). Sales application 132 may also provide for redemption of the purchase credits by providing the user with the discount, item/service, rebate, and/or monetary credit in exchange for the purchase credit. Sales application 132 may set terms of the purchase credits (e.g., redeem only one per visit, a maximum amount to redeem, a time of expiration, etc.).

In various embodiments, merchant server 130 includes other applications 134 as may be desired in particular embodiments to provide features to merchant server 130. For example, other applications 134 may include security applications for implementing device/server-side security features, programmatic server applications for interfacing with appropriate application programming interfaces (APIs) over network 160, or other types of applications. Other applications 134 may contain software programs, executable by a processor, including a graphical user interface (GUI), configured to provide an interface to a user. Other applications 134 may include a loyalty application for providing loyalty accounts and administering a chance game for use with the loyalty accounts, as previously discussed.

Additionally, merchant server 130 includes database 136. Database 136 may include merchant inventory and/or location information. For example, database 136 may include information about available items and/or services. Additionally, database 136 may include information about merchant locations where user 102 may visit. In other embodiments, database 136 may include shipping information for available shipping items and/or services and shipping information for user 102 (e.g., a physical address). After completing payment for an item and/or service, database 136 may include transaction history information. Database 136 may store other information for a chance game, such as odds to win the chance game, credits to provide for the chance game, purchase credits available to win in the chance game, etc.

In various embodiments, merchant server 130 includes at least one network interface component (NIC) 138 adapted to communicate with network 160 including user device 110 and/or payment provider server 140. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Payment provider server 140 may be maintained, for example, by an online payment service provider, which may provide loyalty account and chance game features as well as payment services to user 102. In this regard, payment provider server 140 includes one or more processing applications, which may complete purchases for items and/or services between user device 110 and merchant server 130, access and/or receive transaction histories for the purchases, and provide user 102 with plays of a chance game for a loyalty account of user 102 based on those transaction histories. In one example, payment provider server 140 may be provided by PAYPAL®, Inc. of San Jose, Calif., USA. However, in other embodiments, payment provider server 140 may be maintained by or include a merchant, financial services provider, and/or other service provider, which may provide user account and payment service to user 102. For example, loyalty account, chance game, and purchase features may be provided by EBAY®, Inc. of San Jose, Calif., USA. Although payment provider server 140 is described as separate from merchant server 130, it is understood one or more of the features described below in reference to payment provider server 140 may be incorporated within merchant server 130, and vice versa.

Payment provider server 140 of FIG. 1 includes a loyalty application 150, a transaction processing application 142, other applications 144, a database 146, and a network interface component 148. Loyalty application 150, transaction processing application 142, and other applications 144 may correspond to processes, procedures, and/or applications executable by a hardware processor, for example, a software program. In other embodiments, payment provider server 140 may include additional or different software as required.

Loyalty application 150 may correspond to an application configured to provide loyalty account services including a chance game to user 102 through user device 110. In this regard, loyalty application 150 may include processes that enable user 102 to establish a loyalty account with payment provider server 140. User 102 may submit information to establish the loyalty account, such as an identifier/token for user 102 and/or user device 110, a name, address, payment information, email address, telephone number, or other user information that loyalty application 150 may utilize in establishing a loyalty account. Once a loyalty account is established by user 102 with payment provider server 140, user 102 may receive benefits for one or more merchants corresponding to merchant server 130.

After establishing a loyalty account, payment provider server 140 may provide credits to play a chance game with loyalty game application 120 to user device 110. Credits to play the chance game may be generated by loyalty application 150 and distributed to user device 110 based on transaction histories for purchases by user 102 with merchant server 130 and/or merchants corresponding to merchant server 130 (e.g., merchant retail locations). Thus, after user 102 purchases an item and/or service from merchant server 130 or a merchant corresponding to merchant server 130, loyalty application 150 may provide one or more credits to play a chance game with loyalty game application 120 based on the loyalty account of user 102 and the transaction history for the purchase.

The number of credits provided to user 102 by loyalty application 150 may depend on rules set by merchant server 130, as previously discussed. For example, based on a $5 purchase, user 102 may receive 1 credit to play the chance game. If user 102 spends $10, user 102 may receive 2 credits. Merchant server 130 may also set the number of credits provided by loyalty application 150 to user 102 to be based on the type of item purchased, such as 1 credit for lunch purchases, 2 credits for dinner purchases, 1 credit for a car wash, 5 credits for a car wash, wax, and detailing, etc. Additionally, the past history of the loyalty account may affect the number of credits provided, for example, by providing frequent customers with more credits, by providing more credits to a customer who infrequently purchases or has just performed a first purchase with merchant server 130 in order to incentivize the user, etc. Moreover, the number of credits may depend on a ranking in a scoreboard, as will be discussed in more detail below. Thus, loyalty application 150 may receive rules for providing credits to user 102 from merchant server 130.

Additionally, loyalty application 150 may establish, manage, and enforce odds to win the chance game in loyalty game application 120 based on rules set by merchant server 130. As previously discussed, the chance game may include odds to win, and the odds may dynamically vary/adjust to enforce those odds. Loyalty application 150 may receive odds from merchant server 130 and parameters for those odds, such as if merchant server 130 wishes to dynamically vary the odds to more enforce a win only once in N number of tries, etc. Loyalty application 150 may transmit those odds to loyalty game application 120 and update the odds with loyalty game application 120 based on new odds set by merchant server 130 and/or wins of purchase credits by user 102.

After user 102 wins the chance game with loyalty game application 120, loyalty application 150 may further provide a purchase credit to user 102 through user device 110. The purchase credit provided to user 10 may depend on parameters set by merchant server 130. As previously described, a number and/or type of purchase credit may be won through the chance game. For example, a chance game may correspond to slots, where matching 3 of one type of icon confers one type or number of purchase credits, and matching 3 of another type of icon confers a different type or number of purchase credits. Thus, loyalty application 150 may provide the number and/or type of purchase credits to user 102 based on rules set by merchant server 130.

Loyalty application 150 may further provide a score for user 102 based on one or more transaction histories for user 102 with merchant server 130 and/or a merchant corresponding to merchant server 130. A score may be determined through an amount spent in the transaction history, an item and/or service purchased in the transaction history, etc. The score may further depend on a loyalty account of user 102 and information corresponding to the loyalty account. For example, information in the loyalty account of user 102 may include past purchases, visits to merchant locations, etc., and may affect by user 102's previous score. A score may correspond to progress through the chance game and/or number of wins/plays of the chance game. Thus, users who more frequently purchase items and play the chance game may have a higher score. The score may be utilized to rank user 102 against other users enrolled in the loyalty program and having loyalty accounts the users are utilizing to play the chance game. Additionally, the rankings may be tiered and the scores may be utilized to reach different tiers, such as bronze, silver, gold, etc.

The score in the leaderboard, a transaction history having a specific item/service, merchant, and/or amount spent, and/or other action by user 102 may enable user 102 to unlock achievements. For example, by shopping three times in a week with merchant server 130, user 102 may receive a loyal buyer achievement. Other achievements may include a “diverse shopper” achievement for shopping with a wide plurality of merchants, a “big spender” achievement for a large transaction, etc. Achievements may be utilized to show a progress of user 102 and may be compared to other users. Additionally, the achievements may unlock various features, such as new chance games to play, credits to play the chance game, purchase credits redeemable with a merchant, etc. In various embodiments, the leaderboard may be deployed without using a chance game by the merchant (e.g., merchant server 130). For example, a merchant may choose to simply provide points, rankings, and/or other scoring options based on transactions user 102 may have with the merchant. Thus, if user 102 spends 5 dollars, user 102 may receive 5 points to a score on a leaderboard. In other embodiments, the score may depend on other factors, such as how frequently user 102 purchases with the merchant, items purchased by user 102, etc. The score may depend on or be affected by, in various embodiments, an achievement that user 102 unlocks. Thus, user 102 may move up a leaderboard based on their transaction histories with merchant server 130. Based on their position in the leaderboard using only their transaction histories to affect the score, various benefits may be conferred to user 102, as will be discussed in more detail herein.

The leaderboard may be further utilized to compare user 102 to other users. User 102 may view a ranking for user 102 in the leaderboard based on the score for user 102, and may view leaders, other users with similar rankings, etc. Additionally, the leaderboard may be tied to a map application of user device 110, so that the location of the user in the map may be utilized to find nearby user's that are also engaging in the loyalty programs and playing the chance game. The search distance (e.g., radius from the location of user 102) for finding nearby users and their rank in the scoreboard, may be set by user 102 and may correspond to a zoom of the map application, so that as user 102 zooms in and out of the map, nearby users participating in the leaderboard may be recalculated. The zoom may be configured to include states, countries, and/or the whole world, so that user 102 may view rankings in the leaderboard to the level of abstraction user 102 desires. Additionally, user 102 may select locations on the map, including cities, states, and/or countries, to view the locations leaderboard and compare the score/ranking of user 102 to that location. Thus, a user wishing to compare their score, or their countries score, to another country may select the other country and view the other countries leaderboard along with a comparison selected by the user (e.g., the user's score and/or the user's countries score).

In various embodiments, user 102 may also view a leaderboard for a subset of users, such as a friends list. The leaderboard may therefore be linked to a social networking application, and retrieve friends of user 102 from the social networking application to generate a leaderboard and provide comparisons for user 102. In other embodiments, user 102 may select other users to view and/or compare in the leaderboard through loyalty application 150. For example, user 102 may provide an identifier for another user or search for the other user through loyalty application 150 and request a comparison of achievements, score, and/or ranking, or select to generate a leaderboard with the other user, and potentially a plurality of additional users.

Based on the score and/or the ranking, loyalty application 150 may provide different benefits to user 102 through the loyalty account. These benefits may correspond to the chance game that user 102 plays. For example, a user who has a score of 50 or is in a bronze tier may only receive one type or number of purchase credits for winning the chance game, or may receive only 1 credit to play the chance game when the user spends $5 with merchant server 130. However, a user who has a 150 score or is in a gold tier may be able to win different types or more purchase credits if the user wins the chance game, or the user may receive 3 credits when the user spends $5 with merchant server 130. The ranking may also open up more options to purchase with the purchase credit, such as allowing the user to redeem a free dinner with a number of purchase credits only if the user reaches a gold tier.

While merchant server 130 has delegated loyalty account establishment and management functions, including providing a chance game for use with the loyalty account, to payment provider server 140, in various embodiments, merchant server 130 may include the above described functions. Thus, loyalty application 150 may be provided by merchant server 130, where merchant server 130 includes processes and procedures to establish and maintain loyalty accounts, provide a chance game to user 102 for use with the loyalty account of user 102, and set parameters for the chance game (e.g., odds to win, prizes/purchase credits available to win, a scoreboard for the chance game and/or loyalty accounts, and/or credit distribution for playing the chance game). In such embodiments, payment provider server 140 may be utilized to provide payment services and transaction histories between user device 110 and merchant server 130.

Transaction processing application 142 may be configured to receive information from user device 110 and/or merchant server 130 for processing and completion of financial transactions. Transaction processing application 142 may include one or more applications to process financial transaction information from user device 110 and/or merchant server 130. Transaction processing application 142 may receive a payment request to complete a sale transaction for an item and/or service. Transaction processing application 142 may complete the sale transaction by providing payment to merchant server 130. Transaction processing application 142 may receive a user payment account for user 102 with payment provider server 140 to provide payment to merchant server 130. In other embodiments, transaction processing application 142 may receive user financial information, such as a payment card, bank account, gift card, or other financial information. Transaction processing application 142 may also receive purchase credits as payment for items and/or services with merchant server 130, or as a discount, rebate, etc. Transaction processing application 142 may credit the payment to a payment account of merchant server 130 with payment provider server 140 or to another financial account, such as a bank account. In other embodiments, transaction processing application 142 may provide transaction histories, including receipts, to user device 110 and/or merchant server 130 in order to provide proof or purchase and complete the financial transaction.

In various embodiments, payment provider server 140 includes other applications 144 as may be desired in particular embodiments to provide features to payment provider server 140. For example, other applications 144 may include security applications for implementing server-side security features, programmatic server applications for interfacing with appropriate application programming interfaces (APIs) over network 160, or other types of applications. Other applications 144 may contain software programs, executable by a processor, including a graphical user interface (GUI), configured to provide an interface to a user.

Additionally, payment provider server 140 includes database 146. User 102 and/or merchant server 130 may establish one or more user accounts and/or loyalty accounts with payment provider server 140. User accounts and/or loyalty accounts in database 146 may include user/merchant information, such as name, address, birthdate, payment/funding information, additional user financial information, and/or other user data. In various embodiments, user 102 and/or merchant server 130 may not have previously established a user account for payment services and may provide other financial information to payment provider server 140 to complete financial transactions, as previously discussed. Database 146 may further include information received from merchant server 130, including odds for chance games, parameters for credit and purchase credit distribution, available credit and/or purchase credit types, and other information necessary for providing the chance game with loyalty accounts, as previously discussed.

In various embodiments, payment provider server 140 includes at least one network interface component (NIC) 148 adapted to communicate with network 160 including user device 110 and/or merchant server 130. In various embodiments, network interface component 148 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

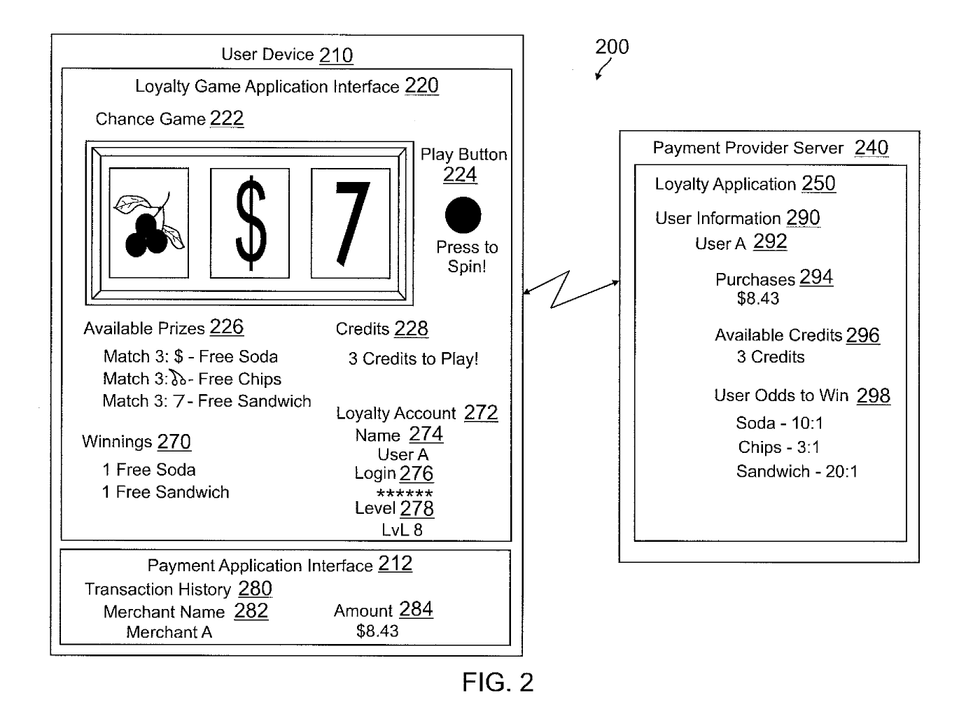

FIG. 2 is an exemplary system environment with a user device displaying a chance game playable by a user, according to an embodiment. FIG. 2 includes a user device 210 and a payment provider server 240 corresponding generally to user device 110 and payment provider server 140, respectively, of FIG. 1.

In environment 200, a user (User A, not shown) utilizes user device 210 to view a loyalty game application interface 220. Loyalty game application interface 220 may correspond to an interface displaying similar executed processes and procedures of loyalty game application 120 of FIG. 1. Additionally, User A may view payment application interface 212 to complete payments with a merchant and generate transaction histories that may be utilized for providing credits to play a chance game. Payment application interface 212 may correspond to an interface displaying similar executed processes and procedures of payment application 112 of FIG. 1. User A has generated transaction history 280 having merchant name 282 for merchant A and amount 284 of $8.43. Transaction history 280 may be transmitted to payment provider server 240 for processing in order to receive credits to play a loyalty game.

Payment provider server 240 includes a loyalty application 250. Loyalty application 250 may correspond generally to similar processes and procedures of loyalty application 150 of FIG. 1. Loyalty application 250 includes user information 290 having a User A 292, purchases 294, available credits 296 and user odds to win 298. User information 290 corresponds to user information in a loyalty account used for providing a chance game to User A. Loyalty application 250 has received transaction history 280 from user device 210 and processed the information to populate User A 292 and purchases 294. Purchases 294 displays the similar amount purchased with merchant A of $8.43. Based on purchases 294, loyalty application 250 has generated available credits 296 to provide to user device 210 for User A to utilize. Additionally, loyalty application 250 has established the odds for User A to win a chance game as user odds to win 298. As shown, User A has 10:1 odds to win a soda, 3:1 odds to win chips, and 20:1 odds to win a sandwich. User odds to win 298 are therefore specific to User A and adjust based on the behaviors of User A, including playing chance game 222, purchases 294, etc. Thus, another user of loyalty application 250 may receive different odds from User A.

Loyalty game application interface 220 displays a chance game 222 to User A. Chance game 222 may correspond to some game that has odds for User A to win. As shown in FIG. 2, chance game 222 corresponds to a slot machine game that has a play button 224. If User A engages play button 224, such as through a touch input in loyalty game application interface 220, chance game 222 may activate and play one or more turns. By pressing play button 224, User A may spend one or more credits 228. Credits 228 show 3 credits provided by payment provider server 240, as shown under loyalty application 250 as available credits 296. Once User A selects play button 224 and spends one or more of credits 228, User A may attempt to match icons shown in chance game 222 to win purchase credits available under available prizes 226. Available prizes 226 shown “Match 3 dollar sign icons—Free Soda,” “Match 3 cherry icons—Free Chips,” and “Match 3 seven icons—Free Sandwich.” If chance game 222 lands on three of any of those types, User A may win a purchase credit for the corresponding item. If User A wins one or more purchase credits for items and/or services with a merchant in chance game 222, the prizes may populate under winnings 270 so that User A may spend the purchase credits. Payment application interface 212 may display those prizes under winnings 270 when paying for an item corresponding to winnings 270 to enable User A to redeem winnings 270. User A may also view loyalty account information, login, and/or score/ranking with a leaderboard through loyalty account 272. Thus, loyalty account 272 includes a name 274 for User A, a login 276 having a password, and a level 278 of LvL 8. As previously discussed, level 278 may correspond to a score, and may include a ranking in a leaderboard. By selecting level 278, User A may view the details of the score, including achievements earned through actions of User A, and may view the leaderboard. When viewing the leaderboard, User A may make comparisons, view leaders, and select which user's to view and/or compare in the leaderboard. Such actions may be facilitated by a map application and/or friends list, whereby User A may select a group of other users to view, compare, and/or rank in a leaderboard.

Chance game 222 may include odds to win as set by a merchant and enforced through payment provider server 240. The chances for User A to win chance game 222 are shown under user odds to win 298. These odds may be set by a merchant and may be dynamically adjusted. For example, as shown in loyalty game application interface 220, User A has winnings 270 of 1 free soda and 1 free sandwich. Since User A already has these purchase credits, the odds under user odds to win 298 are much lower (more unlikely to win) than for a purchase credit for chips. Thus, if User A has not won chips in a while but has won a free soda and/or sandwich, the odds may be more likely that User A wins chips. Other factors may also affect user odds to win 298, such as level 278, amount 284, etc.

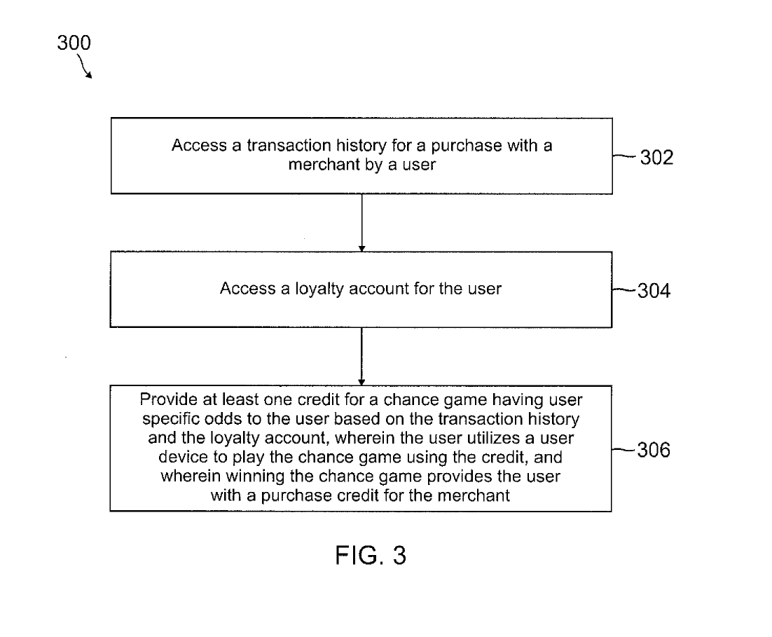

FIG. 3 is a flowchart of an exemplary process for a chance based loyalty program using an interactive game, according to an embodiment. Note that one or more steps, processes, and methods described herein may be omitted, performed in a different sequence, or combined as desired or appropriate.

At step 302, a transaction history for a purchase with a merchant by a user is accessed. The transaction history may be received from one of a user device, a merchant location corresponding to the merchant, and a merchant server corresponding to the merchant.

A loyalty account for a user is accessed, at step 304. The loyalty account may comprise an account with the merchant that confers benefits to the user. At step 306, at least one credit for a chance game is provided to the user based on the transaction history and the loyalty account, wherein the user utilizes a user device to play the chance game using the credit, and wherein winning the chance game provides the user with a purchase credit for the merchant.

The purchase credit may comprise one of a discount, a free item or service, a rebate, and a monetary credit. Additionally, the chance game may comprise one of a card game, a slot machine game, a roulette wheel game, a lottery game, and a matching game. Moreover, the at least one credit may comprise one of a token to initiate a turn or spin of the chance game, an amount to wager during the chance game, and a number or numbers to match during the chance game.

Odds for the chance game may be received, wherein the odds determine a likelihood the user wins the chance game. The odds may be applied to the chance game when the user plays the chance game. The odds may also be dynamically adjusted to enforce a win per number of plays of the chance game by the user. The odds may increase or decrease based on the user's wins of the chance game in a set amount of last plays of the chance game. The purchase credit may correspond to a plurality of items for purchase from the merchant using the purchase credit, wherein the odds are specific to each of the plurality of items.

A score for the user may be determined based on the transaction history and the loyalty account and a ranking in a leaderboard may be assigned using the score, wherein the leaderboard comprises a plurality of users enrolled in a loyalty program corresponding to the chance game. The score may be further determined using winnings in the chance game by the user. Additionally, the ranking in the leaderboard may be utilized to determine a type of item available for purchase with the merchant using the purchase credit. Moreover, at least one of the transaction history, the loyalty account, and the ranking in the leaderboard may be utilized to determine a number of the at least one credit to provide to the user.

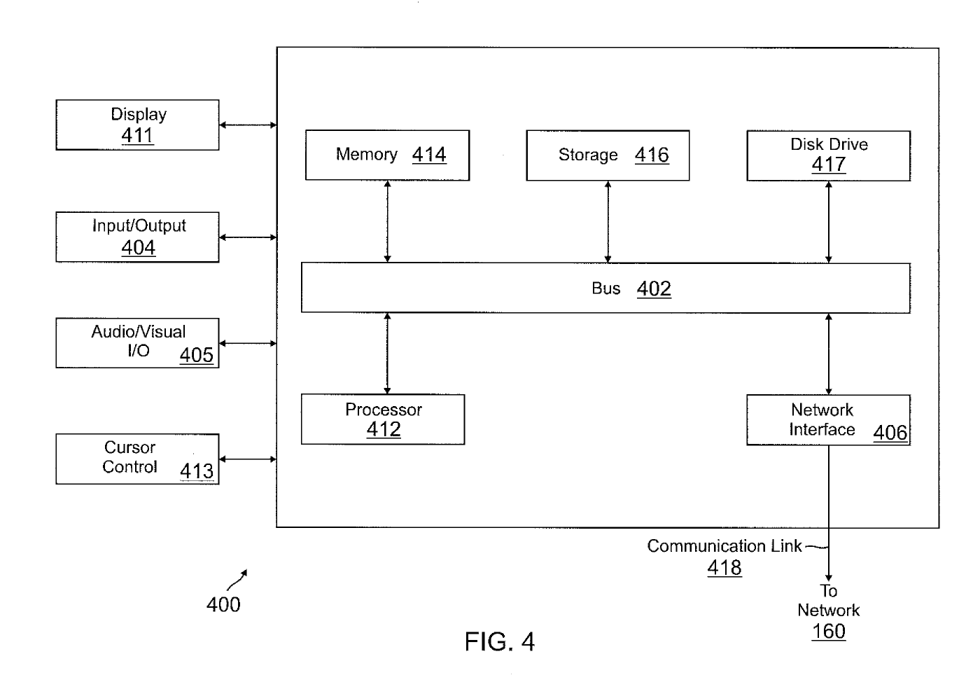

FIG. 4 is a block diagram of a computer system suitable for implementing one or more components in FIG. 1, according to an embodiment. In various embodiments, the user device may comprise a personal computing device (e.g., smart phone, a computing tablet, a personal computer, laptop, wearable computing device, Bluetooth device, key FOB, badge, etc.) capable of communicating with the network. The merchant device and/or service provider may utilize a network computing device (e.g., a network server) capable of communicating with the network. It should be appreciated that each of the devices utilized by users and service providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons, image, or links, and/or moving one or more images, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant device, or a service provider server via network 160. In one embodiment, the transmission is wireless, although other transmission mediums and methods may also be suitable. One or more processors 412, which can be a micro-controller, digital signal processor (DSP), or other processing component, processes these various signals, such as for display on computer system 400 or transmission to other devices via a communication link 418. Processor(s) 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor(s) 412 and other components by executing one or more sequences of instructions contained in system memory component 414. Logic may be encoded in a computer readable medium, which may refer to any medium that participates in providing instructions to processor(s) 412 for execution. Such a medium may take many forms, including but not limited to, non-volatile media, volatile media, and transmission media. In various embodiments, non-volatile media includes optical or magnetic disks, volatile media includes dynamic memory, such as system memory component 414, and transmission media includes coaxial cables, copper wire, and fiber optics, including wires that comprise bus 402, In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing a loyalty account with a merchant for a user; and
one or more hardware processors in communication with the non-transitory memory and configured to:
access a transaction history for a purchase with the merchant by the user;
access the loyalty account for the user; and
provide at least one credit for a chance game having user specific odds to the user based on the transaction history and the loyalty account, wherein the user utilizes a user device to play the chance game using the credit, and wherein winning the chance game provides the user with a purchase credit for the merchant.

2. The system of claim 1, wherein the purchase credit comprises one of a discount, a free item or service, a rebate, and a monetary credit.

3. The system of claim 1, wherein the chance game comprises one of a card game, a slot machine game, a roulette wheel game, a lottery game, and a matching game.

4. The system of claim 3, wherein the at least one credit comprises one of a token to initiate a turn or spin of the chance game, an amount to wager during the chance game, and a number or numbers to match during the chance game.

5. The system of claim 1, wherein the one or more hardware processes is further configured to access the transaction history by:
receiving the transaction history from one of the user device, a merchant location corresponding to the merchant, and a merchant server corresponding to the merchant.

6. The system of claim 1, wherein the one or more hardware processors is further configured to:
receive the user specific odds for the chance game, wherein the user specific odds determine a likelihood the user wins the chance game; and
apply the user specific odds to the chance game when the user plays the chance game.

7. The system of claim 6, wherein the user specific odds are dynamically adjusted to enforce a win per number of plays of the chance game by the user.

8. The system of claim 1, wherein the one or more hardware processors are further configured to:
determine a score for the user based on the transaction history and the loyalty account; and
assign a ranking in a leaderboard using the score, wherein the leaderboard comprises a plurality of users enrolled in a loyalty program corresponding to the chance game.

9. A method comprising:
accessing a transaction history for a purchase with a merchant by a user;
accessing a loyalty account for the user; and
providing, using one or more hardware processors, at least one credit for a chance game having user specific odds to the user based on the transaction history and the loyalty account, wherein the user utilizes a user device to play the chance game using the credit, and wherein winning the chance game provides the user with a purchase credit for the merchant.

10. The method of claim 9 further comprising:
receiving the user specific odds for the chance game, wherein the user specific odds determine a likelihood the user wins the chance game; and
applying the user specific odds to the chance game when the user plays the chance game.

11. The method of claim 10, wherein the user specific odds are dynamically adjusted to enforce a win per number of plays of the chance game by the user.

12. The method of claim 9 further comprising:
determining a score for the user based on the transaction history and the loyalty account; and
assigning a ranking in a leaderboard using the score, wherein the leaderboard comprises a plurality of users enrolled in a loyalty program corresponding to the chance game

13. The method of claim 12, wherein the score is further determined using winnings in the chance game by the user.

14. The method of claim 12 further comprising;
utilizing the ranking in the leaderboard to determine a type of item available for purchase with the merchant using the purchase credit.

15. The method of claim 12 further comprising:
utilizing at least one of the transaction history, the loyalty account, and the ranking in the leaderboard to determine a number of the at least one credit to provide to the user.

16. A non-transitory computer-readable medium comprising instructions which, in response to execution by a computer system, cause the computer system to perform a method comprising:
accessing a transaction history for a purchase with a merchant by a user;
accessing a loyalty account for the user; and
providing at least one credit for a chance game having user specific odds to the user based on the transaction history and the loyalty account, wherein the user utilizes a user device to play the chance game using the credit, and wherein winning the chance game provides the user with a purchase credit for the merchant.

17. The non-transitory computer readable medium of claim 16, wherein the method further comprises:
receiving user specific odds for the chance game, wherein the user specific odds determine a likelihood the user wins the chance game; and
applying the user specific odds to the chance game when the user plays the chance game

18. The non-transitory computer readable medium of claim 17, wherein the user specific odds are dynamically adjusted to enforce a win per number of plays of the chance game by the user.

19. The non-transitory computer readable medium of claim 17, wherein the user specific odds increase or decrease based on the user's wins of the chance game in a set amount of last plays of the chance game.

20. The non-transitory computer readable medium of claim 17, wherein the purchase credit corresponds to a plurality of items for purchase from the merchant using the purchase credit, and wherein the user specific odds are specific to each of the plurality of items.
